(19) United States
(12) Patent Application Publication
(10) Pub. No.: US 2008/0317551 A1
(43) Pub. Date: Dec. 25, 2008

(54) EVAPORATION RETARDING COVER

(76) Inventors: Phillip John Bennett, Birdwood (AU); James Andrew Mills, Edmonton (CA); Jason Jeffery Robert MacQueen, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/766,694

(22) Filed: Jun. 21, 2007

(51) Int. Cl. C02F 1/00; B65D 88/34

(52) U.S. Cl. 405/52

(57) ABSTRACT

An evaporation retarding cover which includes an ultra-violet radiation resistant sheet made from a material that provides a water evaporation retarding barrier. The material has an upper surface and a lower surface. Flexible floatation strips of closed cell foam are thermally bonded to the lower surface.

### FIELD

The present invention relates to a cover that can be used to cover a body of water in order to retard evaporation.

### BACKGROUND

With water shortages being experienced in some portions of the United States, steps are being taken to reduce water losses due to evaporation. When making a decision as to whether or not to use an evaporation retarding cover, the cost of the evaporation retarding cover is a factor. There is a need for a relatively inexpensive evaporation retarding cover. These covers are referred to as evaporation retarding covers even though there may be other factors that motivate their use. For example, evaporation retarding covers are sometimes used to retard algae growth.

### SUMMARY

There is provided an evaporation retarding cover which includes an ultra-violet radiation resistant sheet made from a material that provides a water evaporation retarding barrier. The material has an upper surface and a lower surface. Flexible floatation strips of closed cell foam are thermally bonded to the lower surface.

### BRIEF DESCRIPTION OF THE DRAWINGS

These and other features will become more apparent from the following description in which reference is made to the appended drawings, the drawings are for the purpose of illustration only and are not intended to in any way limit the scope of the invention to the particular embodiment or embodiments shown, wherein:

FIG. 1 is a side view, in section, of an evaporation retarding cover.

FIG. 2 is a bottom plan view of the evaporation retarding cover illustrated in FIG. 1.

FIG. 3 is a perspective view of the evaporation retarding cover illustrated in FIG. 1, being fed from a roll.

FIG. 4 is a side view, in section, of a sump used with the evaporation retarding cover of FIG. 1.

### DETAILED DESCRIPTION

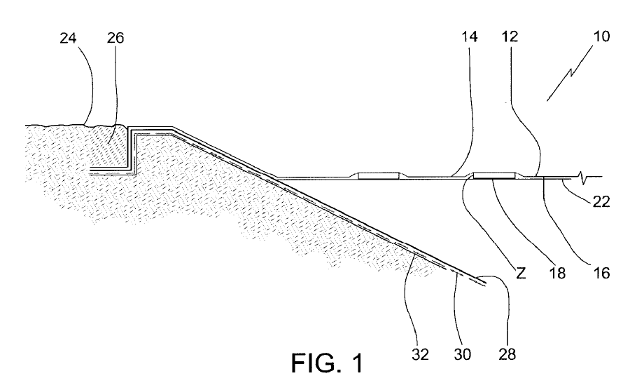

An evaporation retarding cover generally identified by reference numeral 10, will now be described with reference to FIG. 1 through 4.

Structure and Relationship of Parts:

Referring to FIG. 1, evaporation retarding cover 10 consists of an ultra-violet (UV) radiation resistant sheet 12 made from a material that provides a water evaporation retarding barrier. Sheet 12 has an upper surface 14 and a lower surface 16. Flexible floatation strips 18 of closed cell foam are thermally bonded to lower surface 16.

It will be appreciated that there are various ways in which sheet 12 can be made ultra-violet radiation resistant. A UV radiation protective coating may be placed on upper surface 14 or a UV radiation protectant may be dispersed throughout sheet 12. It will also be appreciated that in order to provide a water evaporation retarding barrier, sheet 12 need only be sufficiently impermeable that it serves to slow down water evaporation.

Beneficial results have been obtained when sheet 12 is made of a polyolefin geo-membrane and flexible floatation strips 18 are of a compatible polyolefin closed cell foam. The specific polyolefin geomembrane used in tests was a polyethylene for sheet 12 in combination with a polyethylene closed cell foam for floatation strips 18. In addition, any other polyolefin, blend, or specialty polymer may be used to construct floatation strips 18. One example of a material used to construct floatation strips 18 is polypropylene.

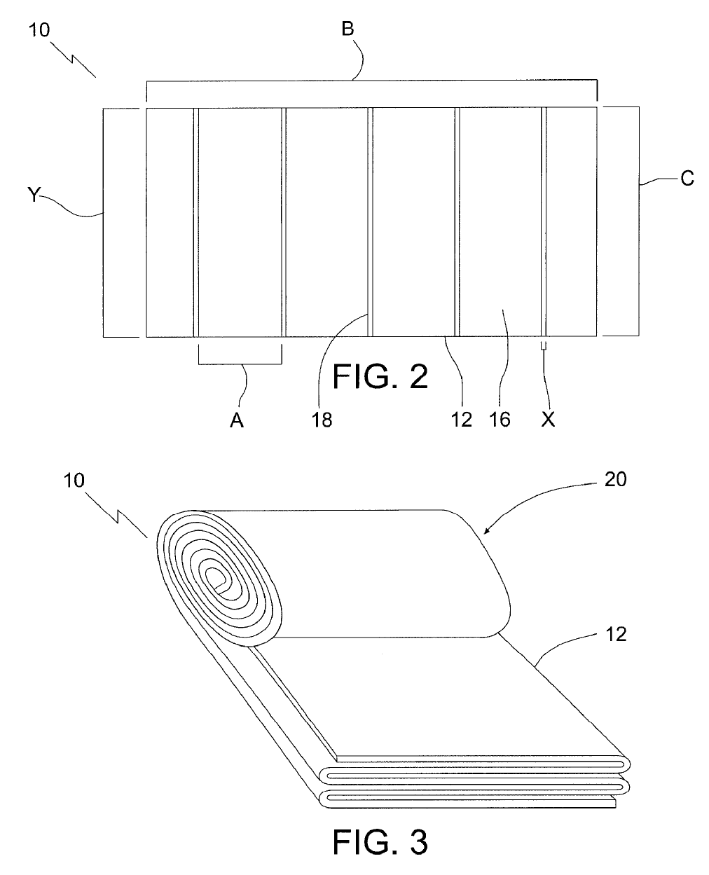

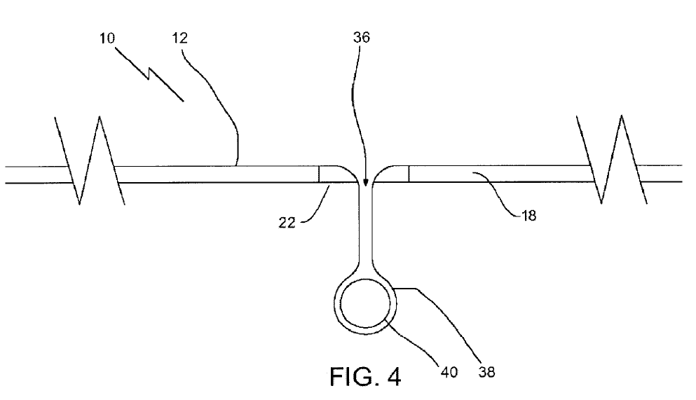

Referring to FIG. 2, floatation strips 18 may be constructed with a width X of between one and three feet, such as two feet wide. Floatation strips 18 are spaced apart from each other as shown in FIG. 2 with a distance A of between forty and fifty feet. It should be understood that other values of distance A larger than fifty feet or less than forty feet may be used. Floatation strips 18 may have a length Y around one hundred feet, or another suitable length. Referring to FIG. 1, floatation strips 18 may have a thickness Z of one half of an inch. Alternatively, other values of thickness Z are possible. Thickness Z must be thick enough to allow evaporation retarding cover 10 to float while being thin enough to allow evaporation retarding cover 10 to be rolled into a roll 20 (shown in FIG. 3).

Floatation strips 18 may be attached to sheet 12 by thermal bonding. Hot air, hot wedge, or any other suitable welding equipment may be used. Floatation strips 18 may be welded continuously along its edges to sheet 12. In addition, floatation strips 18 may be attached to sheet 12 at the place of construction of evaporation retarding cover 10. It is advantageous to attach floatation strips 18 to sheet 12 in the factory as opposed to the field. This is due to the fact that factory welding equipment is more reliable and practical to use than similar equipment used in the field. It also may be impractical to weld floatation strips 18 to sheet 12 in the field, because floatation strips 18 are to be welded to lower surface 16 of sheet 12. Referring to FIG. 1, this would be difficult if sheet 12 is being installed over a body of water 22.

Referring to FIG. 2, sheet 12 is constructed with a length B of two hundred feet and a width C of one hundred feet. It should be understood that other values for length B and width C are possible. Length Y of floatation strips 18 may be equal to width C of sheet 12. More commonly, referring to FIG. 4, there are breaks 36 for the formation of sumps 38 for drainage and to take up slack as water levels rise and fall. Sumps 38 may support sand tubes 40. Sand tubes 40 provide a source of weight that allows sumps 38 to provide tension to sheet 12. This design allows sumps 38 to act as expansion joints in situations where expansion and contraction are of concern. As can be seen in FIG. 4, there would be a gap in flotation strips 18, such that they would not extend under sump 38. There may be other gaps in flotation strips 18, such as where sheet 12 extends onto shore. It will appreciated that evaporation retarding cover 10 may come in various shapes and sizes.

Referring to FIG. 3, it is preferred, but not essential that sheet 12 with flexible floatation strips 18 (shown in FIG. 1) attached be formed into roll 20. This may be accomplished by folding sheet 12 in an accordion fashion and then rolling it into roll 20. The fact that sheet 12 can be formed into roll 20 with flexible floatation strips 18 attached, provides an indication of how flexible floatation strips 18 are. It is useful to form evaporation retarding cover 10 into roll 20 for transportation.

Operation:

In the prior art, evaporation retarding covers were generally installed after water was drained from the pond or prior to filling of the pond. The reason for this was that it was necessary to assemble a framework of floats and secure the framework of floats on top of the evaporation retarding cover. This could only be done when the pond was empty. Measures were then taken to protect the framework of floats from UV radiation, as the closed cell foam rapidly deteriorates when exposed to UV radiation. Because the floats were attached to the top of the geomembrane in the prior art, an additional covering of geomembrane was required over each float.

Referring to FIG. 1, evaporation retarding cover 10 can be floated into place on body of water 22. There is no need to drain the pond or make other provisions for assembly, as flexible floatation strips 18 are thermally bonded to sheet 12, so that they are an integral part of evaporation retarding cover 10. There is no need to take measures to protect flexible floatation strips 18 from UV radiation, as flexible floatation strips 18 are sheltered from UV radiation by sheet 12. Flexible floatation strips 18 are sufficiently flexible that evaporation retarding cover 10 can still be formed into roll 20 (shown in FIG. 3), for ease of handling and transportation. The use of a lighter floatation system, enables the thickness of sheet 12 to be reduced, which further reduces overall cost. The preferred form of folding is first into an “accordion” fold and then into a roll. When delivered to a body of water, roll 20 is unrolled and then deployed by pulling along one edge to unfold in stages the accordion fold.

Referring to FIG. 1, once in place over body of water 22, evaporation retarding cover 10 may be secured to a shore 24. It should be understood that there are numerous ways of affixing cover 10 to shore 24. One method of securing evaporation retarding cover 10 to shore 24 may be accomplished by burying one end of cover 10 in a compacted fill-in anchor trench 26. In addition to securing cover 10 to shore 24, anchor trench 26 may also secure a liner 28 and an underlay 30. Liner 28 and underlay 30 may be provided along a bottom 32 of body of water 22, in order to prevent water loss to the surroundings. Liner 28 may be made from geomembrane materials, while underlay 30 may be made from geotextile materials.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiments without departing from scope of the Claims.

What is claimed is:

1. An evaporation retarding cover, comprising:
an ultra-violet radiation resistant sheet made from a material that provides a water evaporation retarding barrier, the material having an upper surface and a lower surface;
flexible floatation strips of closed cell foam thermally bonded to the lower surface.

2. The evaporation retarding cover of claim 1, wherein the sheet material is a polyolefin geo-membrane and the flexible floatation strips are of a compatible polyolefin closed cell foam.

3. The evaporation retarding cover of claim 1, wherein the sheet material with flexible floatation strips attached are formed into a roll.

4. The evaporation retarding cover of claim 1, wherein the ultra-violet radiation resistant sheet comprises an expansion joint, the expansion joint having a weight for applying a tensioning force to the sheet.

5. The evaporation retarding cover of claim 1, wherein the ultra-violet radiation resistant sheet comprises a sump portion, the sump portion having a weight for lowering the sump portion relative to the sheet.
